(19) United States
(12) Patent Application Publication
(10) Pub. No.: US 2025/0251969 A1
(43) Pub. Date: Aug. 7, 2025

(54) SERVICE TRANSFER METHOD, AND ELECTRONIC DEVICE

(71) Applicant: GUANGDONG OPPO MOBILE TELECOMMUNICATIONS CORP., LTD., Dongguan (CN)

(72) Inventors: Xingjian QI, Dongguan (CN); Jianfeng WANG, Dongguan (CN); Xuankai LI, Dongguan (CN); Chengyi TU, Dongguan (CN)

(21) Appl. No.: 19/188,983

(22) Filed: Apr. 24, 2025

Related U.S. Application Data
(63) Continuation of application No. PCT/CN2023/125983, filed on Oct. 23, 2023.

(30) Foreign Application Priority Data
Oct. 31, 2022 (CN) 202211350707.6

(51) Int. Cl. G06F 9/48; G06F 11/14

(52) U.S. Cl. CPC G06F 9/4862; G06F 11/1448

(57) ABSTRACT

Provided are a service transfer method and an electronic device. In the method, a first device stores, through a first data management module, persistent data and temporary data of a target application produced during running of the target application as stored data, and sends the stored data to a second device through the first data management module. The second device receives the stored data through a second data management module, and runs the target application based on the stored data upon completion of backing up the stored data.

### CROSS-REFERENCE OF RELATED APPLICATION

This application is a continuation of International Application No. PCT/CN 2023/125983 filed Oct. 23, 2023, which claims priority to Chinese Patent Application No. 202211350707.6 filed on Oct. 31, 2022. All contents of them are incorporated herein by reference.

### TECHNICAL FIELD

The present disclosure relates to the field of computer technology, and in particular to a service transfer method, and an electronic device.

### BACKGROUND

With the improvement of people's living standards, portable devices such as smartphones become the most commonly used smart devices. People can watch videos, listen to music, browse the web or read e-books on such smart devices, which is very convenient.

However, due to reasons such as battery power or user habits, the users often have a need to transfer a service on their smartphones.

### SUMMARY

Embodiments of the present disclosure provide a service transfer method, and an electronic device.

In a first aspect, the embodiments of the present disclosure provide a service transfer method for a first device, where a first data management module is run on the first device. The method includes:
storing, through the first data management module, data of a target application as stored data, where the stored data includes persistent data and temporary data of the target application produced during running of the target application; and
sending, through the first data management module, the stored data to a second device, so that the second device runs the target application based on the stored data upon completion of backing up the stored data through a second data management module, where the second data management module is run on the second device.

In a second aspect, the embodiments of the present disclosure provide a service transfer method for a second device, where a second data management module is run on the second device. The method includes:
receiving, through the second data management module, stored data sent by a first device through a first data management module, where the stored data is obtained by storing, through the first data management module at the first device, data of a target application produced during running of the target application, and the stored data includes persistent data and temporary data of the target application produced during the running of the target application; and
running the target application based on the stored data, upon completion of backing up the stored data.

In a third aspect, the embodiments of the present disclosure provide an electronic device including: a memory storing executable program codes, and a processor coupled to the memory.

The processor is configured to call the executable program codes stored in the memory, and the executable program codes, when being executed by the processor, cause the processor to implement the method disclosed in the first aspect of the embodiments of the present disclosure.

The details of one or more embodiments of the disclosure are set forth in the accompanying drawings and the description thereof below. Other features and advantages of the present disclosure will be apparent from the description, drawings and claims.

### BRIEF DESCRIPTION OF THE DRAWINGS

In order to more clearly illustrate the technical solutions of the embodiments of the present disclosure, the drawings required for use in the description of the embodiments and the related art will be briefly introduced below. Apparently, the drawings described below are only some embodiments of the present disclosure, and other drawings can be obtained based on these drawings.

FIG. 1A is a diagram schematically illustrating a service transfer as disclosed in the related art.

FIG. 1B is a diagram schematically illustrating another service transfer as disclosed in the related art.

FIG. 1C is a structural diagram of a transfer module as disclosed in the related art.

FIG. 1D is a diagram schematically illustrating a further service transfer as disclosed in the related art.

FIG. 1E is a diagram schematically illustrating a service transfer system as disclosed in the embodiments of the present disclosure.

FIG. 1F is another diagram schematically illustrating the service transfer system as disclosed in the embodiments of the present disclosure.

FIG. 2A is a flowchart of a service transfer method as disclosed in the embodiments of the present disclosure.

FIG. 2B is a flowchart of a service transfer method applicable to FIG. 1E as disclosed in the embodiments of the present disclosure.

FIG. 2C is a flow chart of a service transfer method applicable to FIG. 1F as disclosed in the embodiments of the present disclosure.

FIG. 3A is another flowchart of the service transfer method as disclosed in the embodiments of the present disclosure.

FIG. 3B is a diagram schematically illustrating a merge operation performed on stored data as disclosed in the embodiments of the present disclosure.

FIG. 4 is a structural block diagram of a service transfer apparatus as disclosed in the embodiments of the present disclosure.

FIG. 5 is another structural block diagram of a service transfer apparatus as disclosed in the embodiments of the present disclosure.

FIG. 6 is a further structural block diagram of a service transfer apparatus as disclosed in the embodiments of the present disclosure.

FIG. 7 is a structural block diagram of a first device as disclosed in the embodiments of the present disclosure.

FIG. 8 is a structural block diagram of a second device as disclosed in the embodiments of the present disclosure.

FIG. 9 is a structural block diagram of a cloud server as disclosed in the embodiments of the present disclosure.

### DETAILED DESCRIPTION OF PREFERRED EMBODIMENTS

The embodiments of the present disclosure provide a service transfer method and apparatus, an electronic device, a system and a storage medium, by which limitations on service transfer can be effectively reduced.

In order to enable those skilled in the art to better understand the solutions of the present disclosure, the technical solutions in the embodiments of the present disclosure will be described below in conjunction with the drawings in the embodiments of the present disclosure. Apparently, the described embodiments are only a part of embodiments of the present disclosure, rather than all of the embodiments. All based on the embodiments in the present disclosure should fall within the scope of protection of the present disclosure.

It can be understood that the electronic devices (first device and second device) involved in the embodiments of the present disclosure may include common handheld electronic terminals with a screen, such as mobile phones, smart phones, portable terminals, terminals, personal digital assistants (PDAs), portable multimedia players (PMPs), laptop computers, notebooks (Note Pad), wireless broadband (Wibro) terminals, personal computers (PCs), smart PCs, point of sales (POS) and car computers.

The electronic devices may also include wearable devices. The wearable device is a portable electronic device that can be worn directly on a user or integrated into the user's clothing or accessories. The wearable device is not just a hardware device, but can also realize powerful intelligent functions, such as a computing function, a positioning function, and an alarm function, through software support, data interaction, and cloud server interaction. The wearable device may also be connected to a mobile phone and various terminals. The wearable device may include, but are not limited to, watch-like wearable devices worn on the wrist (such as watches, and bracelets), shoe-like wearable devices worn on the feet (such as shoes, socks or other products worn on the legs), glass-like wearable devices worn on the head (such as glasses, helmets, and headbands), as well as smart clothing, backpacks, crutches, accessories and other non-mainstream product forms.

In order to help those skilled in the art to clearly understand the process of service transfer, a service transfer scenario is described below in conjunction with a first device and a second device. First, a target application is run on the first device. After running for a certain period of time, the user wants to transfer the service of the target application to the second device due to the battery power of the first device or user requirements or other reasons, so that the second device can continue the user activity of the target application on the first device.

In the related art, when the target application is a document application, the sending terminal and the receiving terminal usually use a cloud disk or distributed files for the service transfer. Since the core of the document application is mostly focused on document editing and browsing, the corresponding service can be transferred as long as the document data can be synchronized. However, for applications that are not mainly focused on document editing and browsing, the transfer of their corresponding services may rely heavily on memory data and behavior data produced during running, which are mostly difficult to transfer through cloud disks or distributed files. That is, the service transfer based on cloud disks or distributed files is often only applicable to document applications.

In order to solve this problem, at present, the service transfer is usually implemented with participation of an application, that is, the application has to run on the sending terminal during the service transfer process. If the application is not running (exits the life cycle) on the sending terminal, the corresponding service cannot be transferred.

At present, the participation of an application in the service transfer process is implemented in the following ways.

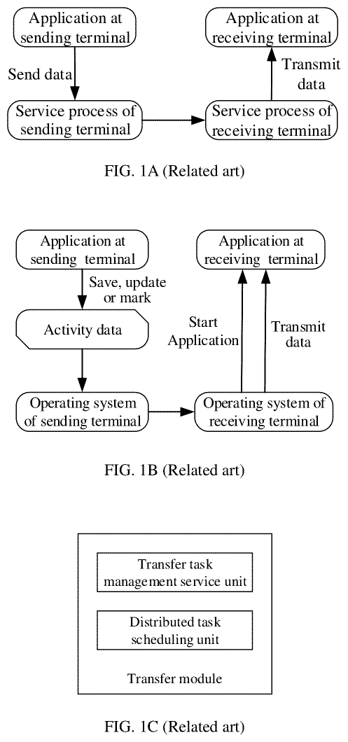

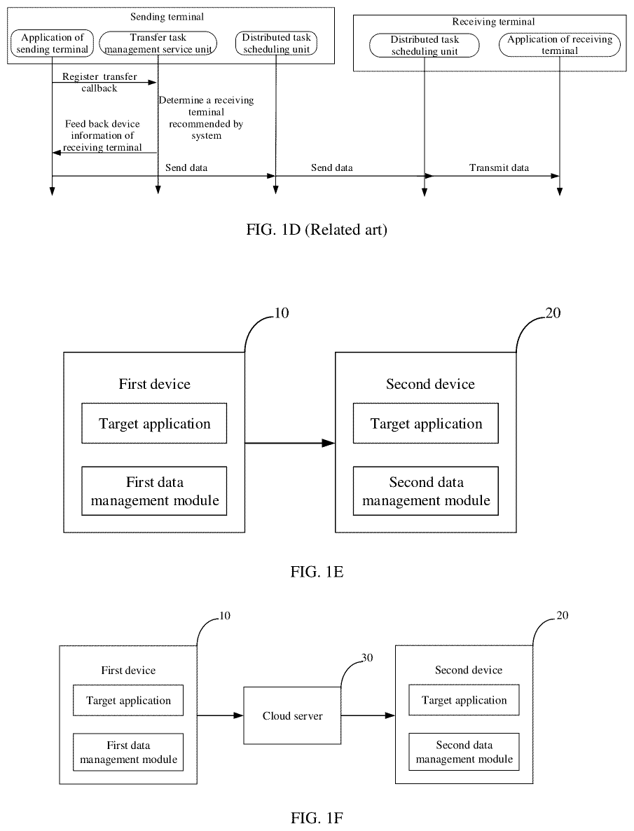

Example 1: as illustrated in FIG. 1A, the sending terminal sends, to a service process of the sending terminal, data of an application produced during running of the application, and the service process of the sending terminal sends the data to a service process of the receiving terminal. When the application is started at the receiving terminal, the service process of the receiving terminal transmits the data to the application, and the application parses the data to restore the active state of the application at the sending terminal.

Example 2: as illustrated in FIG. 1B, an application of the sending terminal writes, into a memory space, activity data describing the user activity status of the application, and the application updates and marks the user activity data written into the memory space. The operating system of the sending terminal reads the activity data from the memory space, and sends the activity data to the operating system of the receiving terminal. The operating system of the receiving terminal starts the application upon receiving the activity data, and transmits the activity data to the application. The application may parse the activity data to restore the active state of the application at the sending terminal.

Example 3: the service transfer is implemented relying on a transfer module, each of the sending terminal and the receiving terminal runs the transfer module. The transfer module includes a transfer task management service unit and a distributed task scheduling unit (see FIG. 1C). The specific transfer process is illustrated in FIG. 1D. At the sending terminal, an application registers a transfer callback on the transfer task management service unit; the transfer task management service unit determines a receiving terminal recommended by the system and feeds back device information of the receiving terminal to the application; and upon receiving the device information, the application sends, to the distributed task scheduling unit, data thereof produced during running of the application, and the distributed task scheduling unit sends the data to the receiving terminal. Upon receiving the data, the distributed task scheduling unit of the receiving terminal transmits the data to the application, and the application may parse the data to restore the active state of the application at the sending terminal.

In order to overcome the limitation that existing service transfer requires participation of the application, in the technical solutions of the present disclosure, a first data management module is run on the first device, and a second data management module is run on the second device. The first device stores, through the first data management module, persistent data and temporary data of a target application that are produced during running of the target application as stored data, and sends the stored data to the second device through the first data management module. The second device receives the stored data through the second data management module, and upon completion of backing up the stored data, the second device runs the target application based on the stored data. Since the stored data includes not only the persistent data of the target application produced during the running of the target application, but also the temporary data, the service of the target application can be transferred from the first device to the second device regardless of whether the target application is running on the first device, which effectively reduces the limitations on the service transfer.

In the embodiments of the present disclosure, two types of service transfer system are involved. The first type of service transfer system includes multiple devices that need to perform the service transfer, and the second type of service transfer system includes multiple devices and a cloud server that need to perform the service transfer. Exemplarily, the first type of service transfer system is illustrated in FIG. 1E. The service transfer system shown in FIG. 1E includes a first device 10 and a second device 20. The second type of service transfer system is illustrated in FIG. 1F. The service transfer system shown in FIG. 1F includes a first device 10, a second device 20 and a cloud server 30.

In combination with the above service transfer systems, the method of synchronizing stored data between the first device and the second device is described below.

In the service transfer system shown in FIG. 1E, the first device 10 and the second device 20 establish a communication link therebetween through their respective short-range communication modules, and synchronously the stored data through the communication link. The short-range communication module may include but is not limited to any one of a near field communication (NFC) module, a Bluetooth module, and an ultra wideband (UWB) communication module.

In the service transfer system shown in FIG. 1F, the first device 10 and the second device 20 synchronize the stored data in such a manner that the first device 10 synchronizes the stored data to the cloud server 30, and the cloud server 30 then sends the stored data to the second device 20.

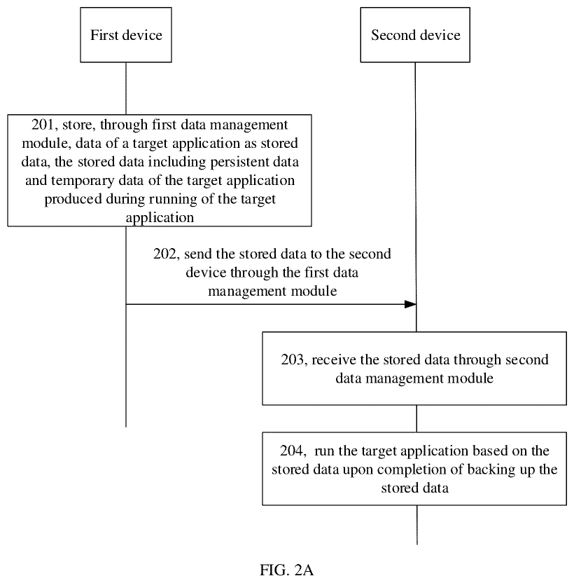

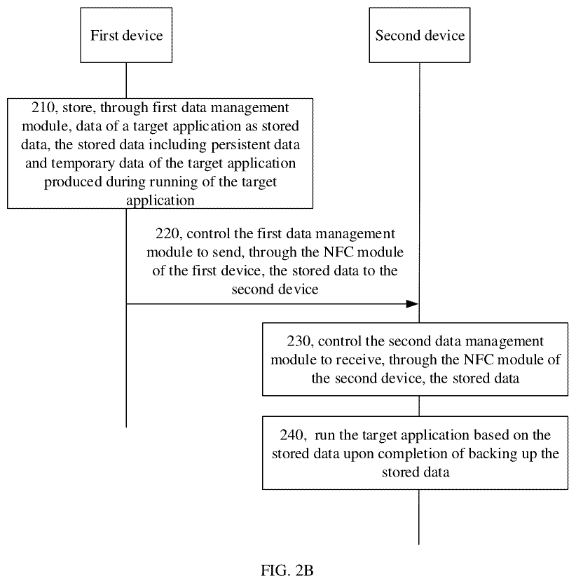

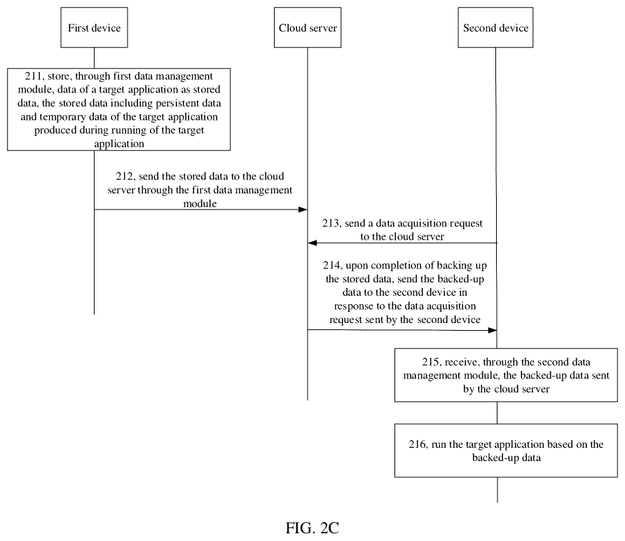

Hereafter, in combination with the aforementioned scenarios, the service transfer methods disclosed in the embodiments of the present disclosure are described in detail. As illustrated in FIG. 2A, a flowchart of a service transfer method disclosed in the embodiments of the present disclosure is shown. The service transfer method shown in FIG. 2A may include operations 201-204 as follows.

At 201, the first device stores, through the first data management module, data of a target application as stored data, where the stored data includes persistent data and temporary data of the target application produced during running of the target application.

The target application may be any application installed on the first device. The persistent data refers to data in a file, which generally does not disappear after the application exits. The temporary data refers to data that is not written to a file and is stored in the memory space, which disappears after the application exits.

Exemplarily, the temporary data may include the content of a short message that is being edited but not yet sent, the Uniform Resource Locator (URL) and playback position of a video that is being played, the location of a document that is being edited, the input, output and intermediate results of an ongoing calculation, video information buffered in viewing a video, etc.

In some embodiments, the first device storing, through the first data management module, the data of the target application as the stored data may include that: the first data management module of the first device backs up, from the memory space, the temporary data of the target application produced during the running of the target application, and backs up, from the file, the persistent data of the target application produced during the running of the target application.

In some embodiments, the data of the target application may include but is not limited to the following types: a document type, a running status type, a configuration type, etc. The data of the target application produced during the running of the target application may be stored in a way shown in Table 1. Data of the running status type and data of the application configuration type can not only be written into the memory space, but also written into the file from the memory; data of the document type and other persistent data are directly written into the file; and other non-persistent data (temporary data) are only stored in the memory space.

TABLE 1

Save location

| | | Stored it in a file, and data |
|---|---|---|
| | Stored in | copy in memory is |
| | memory space | consistent with the file as |
| Data Type | only | much as possible. |
| Document of the application | x | ✓ |
| Running status | ✓ | ✓ |
| Application configuration | ✓ | ✓ |
| Other persistent data | x | ✓ |
| Other non-persistent data | ✓ | x |

In some embodiments, the first device may store, through the first data management module, the data of the target application as the stored data, in response to a service transfer operation for the target application. In some implementations, the service transfer operation may include, but is not limited to: a voice input including information about transferring the service of the target application, a first designated gesture, etc.

In some embodiments, the first device may output, when the battery power is lower than a power threshold, first prompt information indicating that the service of the target application is to be transferred, which is helpful to improve the intelligence level of the service transfer.

At 202, the first device sends the stored data to the second device through the first data management module.

In some embodiments, the first device may store a device identifier list preset by a user, and the device identifier list may include a device identifier of at least one secure device.

Furthermore, the first device sending the stored data to the second device through the first data management module may include that: the first device determines an electronic device matching a target device identifier selected from the device identifier list as the second device, and sends the stored data to the second device through the first data management module.

Exemplarily, the first device and the second device may both be electronic devices owned by the user. With this method, it can be ensured that the service of the target application is transferred to the secure device, which is beneficial to protecting the user privacy.

At 203, the second device receives the stored data through the second data management module.

In some embodiments, the way for the first device and the second device to synchronize the stored data may include but is not limited to the following approaches:

Approach 1: The first device controls the first data management module to send, through the NFC module of the first device, the stored data to the second device, and the second device controls the second data management module to receive, through the NFC module of the second device, the stored data.

Approach 2: The first device performs, through the first data management module, a merge operation on the stored data to obtain merged data, and controls the first data management module to send, through the NFC module of the first device, the merged data to the second device. The second device controls the second data management module to receive, through the NFC module of the second device, the merged data.

Approach 3: The first device sends the stored data to the cloud server through the first data management module. Upon completion of backing up the stored data, the cloud server sends the backed-up data to the second device in response to a data acquisition request sent by the second device. The backed-up data is the stored data or merged data obtained by performing, at the cloud server, a merge operation on the stored data. The cloud server is configured to synchronize the data between the first data management module and the second data management module. The second device receives, through the second data management module, the backed-up data sent by the cloud server.

At 204, the second device runs the target application based on the stored data, upon completion of backing up the stored data.

It is notable that the completion of backing up the stored data by the second device means that the second device completes the reception of the stored data, or the second device completes the reception of the merged data.

After the second device completes the receipt of the stored data, the second device may also perform a merge operation on the stored data to obtain merged data, and run the target application based on the merged data.

Based on the above description, a service transfer method applicable to the service transfer system shown in FIG. 1E may refer to FIG. 2B. The service transfer method shown in FIG. 2B may include operations 210-240 as follows.

At 210, the first device stores, through the first data management module, data of a target application as stored data, where the stored data includes persistent data and temporary data of the target application produced during running of the target application.

At 220, the first device controls the first data management module to send, through the NFC module of the first device, the stored data to the second device.

At 230, the second device controls the second data management module to receive, through the NFC module of the second device, the stored data.

At 240, the second device runs the target application based on the stored data, upon completion of backing up the stored data.

Based on the above description, a service transfer method applicable to the service transfer system shown in FIG. 1F may be referred to FIG. 2C. The service transfer method shown in FIG. 2C may include operations 211-216 as follows.

At 211, the first device stores, through the first data management module, data of a target application as stored data, where the stored data includes persistent data and temporary data of the target application produced during running of the target application.

At 212, the first device sends the stored data to the cloud server through the first data management module.

At 213, the second device sends a data acquisition request to the cloud server.

At 214, upon completion of backing up the stored data, the cloud server sends the backed-up data to the second device in response to the data acquisition request sent by the second device.

At 215, the second device receives, through the second data management module, the backed-up data sent by the cloud server.

At 216, the second device runs the target application based on the backed-up data.

The following further describes the above service transfer methods based on the scenarios.

Scenario 1: A user opens application X on device A and performs an activity thereon, then device A exits application X. Device A synchronizes the data of application X produced during running of application X to the cloud server in real time. When device A is no longer accessible to the user due to movement of the user, the user turns on the accessible device B. Device B may request, from the cloud server, the data of application X produced during running of application X on the first device, start application X, and control application X to automatically recover, based on the data, the last activity of application X performed on device A.

Scenario 2: The user runs application Y on device C. Device C exits application Y due to the battery power or a need to use other applications. When device D is close to device C, device C may synchronize, through the NFC module of device C, the data of application Y produced during running of application Y to device D. After device D completes synchronization of the data, device D may start application Y and control application Y to automatically recover, based on the data, the last activity of application Y performed on device C.

With the above methods, the first device stores, through the first data management module, the persistent data and temporary data of the target application produced during running of the target application as stored data, and sends the stored data to the second device through the first data management module. The second device receives the stored data through the second data management module, and upon completion of backing up the stored data, the second device runs the target application based on the stored data. Since the stored data includes not only the persistent data of the target application produced during running of the target application, but also the temporary data, the service of the target application can be transferred from the first device to the second device regardless of whether the target application is running on the first device, which effectively reduces the limitations on the service transfer. It is notable that, in the embodiments o the disclosure, the first data management module may be implemented as part of the processor of the first device, or implemented as a separate processing chip or control chip in the first device; similarly, the second data management module may be implemented as part of the processor of the second device, or implemented as a separate processing chip or control chip in the second device.

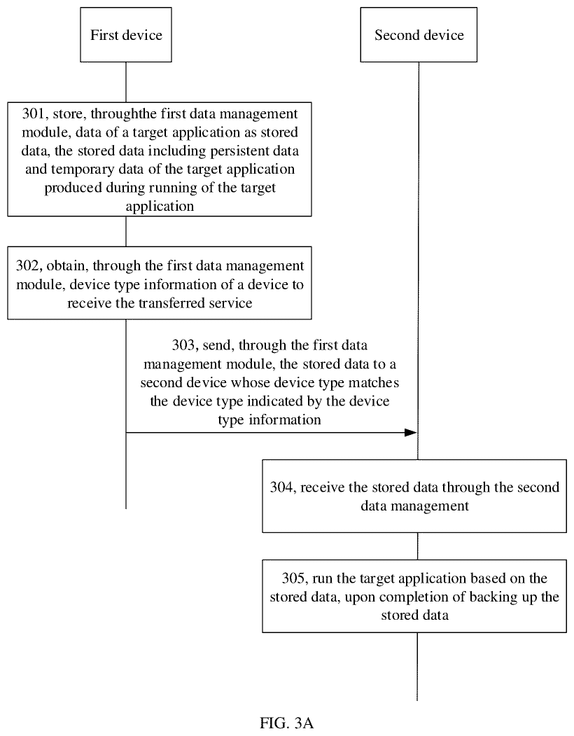

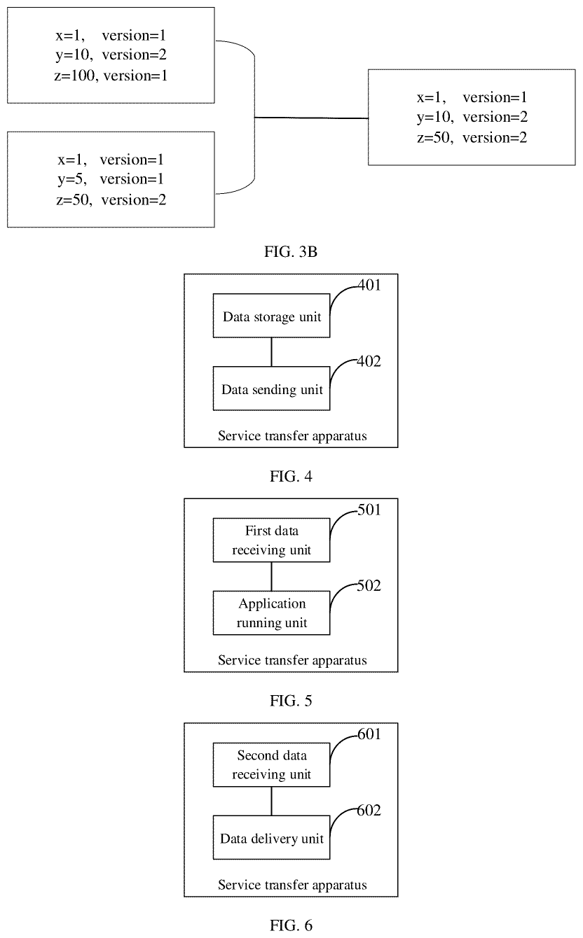

In the embodiments of the present disclosure, the first device may send the stored data to a second device suitable for running the target application. Specifically, as illustrated in FIG. 3A, another flowchart of the service transfer method disclosed in the embodiments of the present disclosure is shown. The service transfer method shown in FIG. 3A may include operations 301-305 as follows.

At 301, the first device stores, through the first data management module, data of a target application as stored data, where the stored data includes persistent data and temporary data of the target application produced during running of the target application.

In some embodiments, storing, through the first data management module, the data of the target application as the stored data may include: performing, by the first device through the first data management module, a block operation on the data of the target application and obtaining at least one data block through the block operation, and establishing a version record about the at least one data block, where the version record includes a data block identifier and a version identifier of each of the at least one data block, and storing the at least one data block and the version record as the stored data.

The data block identifier is used to uniquely identify a data block, and the version identifier is used to identify the version of the data block. It is notable that the version of a data block is related to the storage time of the data block. The later the storage time, the newer the corresponding version. Exemplarily, the version identifier of a data block may be a storage time point of the data block. The data block identifier or version identifier may be composed of at least one of numbers, letters, special characters, etc.

In some embodiments, performing, through the first data management module, the block operation on the data of the target application and obtaining at least one data block through the block operation may include: performing, through the first data management module, the block operation on the data of the target application according to a data type and/or data entry, and obtaining the at least one data block through the block operation.

At 302, the first device obtains, through the first data management module, device type information of a device to receive the transferred service.

In some embodiments, the device type information may include a device type and/or a device type identifier indicating the device type.

In some embodiments, the first device obtaining, through the first data management module, the device type information of the device to receive the transferred service may include but is not limited to:

obtaining, by the first device through the first data management module, the device type information of a device to receive the transferred service, in response to an input operation for a device type. The input operation for the device type may include but is not limited to: a voice input including information about the device type of the device to receive the transferred service, a second designated gesture, etc.

In some embodiments, a pre-set service transfer device list may be stored in the first device. The service transfer device list may include multiple application identifiers and device types respectively corresponding to the application identifiers. Each application identifier is used to uniquely identify one application. The first device may use the first data management module to search the service transfer device list for a device type corresponding to the application identifier of the target application.

Exemplarily, the service transfer device list includes application identifier 1, application identifier 2 and application identifier 3. The device type corresponding to application identifier 1 is a personal computer (PC), the device type corresponding to application identifier 2 is a mobile phone and a tablet computer, and the device type corresponding to application identifier 3 is a smart watch.

At 303, the first device sends, through the first data management module, the stored data to a second device whose device type matches the device type indicated by the device type information.

Operation 303 is further described below in conjunction with the service transfer systems shown in FIG. 1E and FIG. 1F.

In the embodiments of the present disclosure, in order to avoid the service of the target application from being transferred to an unsuitable device, the first device or the cloud server may first identify the device type of the second device before sending the stored data to the second device, and send the stored data to the second device when the identification result indicates that the device type of the second device matches the device type indicated by the device type information.

In the service transfer system shown in FIG. 1E, the first device and the second device synchronously the stored data through the NFC modules. The first device may directly obtain the device type of the second device through the NFC module of the first device, and then determine whether the device type of the second device matches the device type indicated by the device type information. When the device type of the second device matches the device type indicated by the device type information, the first device controls the first data management module to send, through the NFC module of the first device, the stored data to the second device.

In the service transfer system shown in FIG. 1F, the data acquisition request sent by the second device to the cloud server may carry the device type of the second device. The first device may report the device type information to the cloud server through the first data management module. When the cloud server receives the data acquisition request sent by the second device, the cloud server parses the device type of the second device from the data acquisition request, and compares the device type of the second device with the device type indicated by the device type information, and sends the stored data to the second device when the device type of the second device matches the device type indicated by the device type information.

The merge operation performed on stored data is described below in conjunction with the operation of storing the data of the target application data in blocks mentioned in step 301. Target data block identifiers corresponding to a version identifier indicating the latest version are determined from the version record, and data blocks corresponding to the target data block identifier are taken as the merged data.

As illustrated in FIG. 3B, a diagram schematically illustrating a merge operation performed on the stored data provided in the embodiments of the present disclosure is shown. In FIG. 3B, x, y, and z represent data blocks, the corresponding values refer to data in the data blocks, and “version” refers to the version of the corresponding data block. The larger the value of “version”, the higher the version of the corresponding data block. In the merge operation, the data in the data block with a higher version will overwrite the data in the data block with a lower version.

At 304, the second device receives the stored data through the second data management module.

For the detailed description of operation 304, reference may be made to the description of operation 203, which will not be repeated here.

At 305, the second device runs the target application based on the stored data, upon completion of backing up the stored data.

In some embodiments, the second device running the target application based on the stored data upon completion of backing up the stored data may include but is not limited to:
the second device may automatically start the target application upon completion of backing up the stored data, and run the target application based on the stored data; or
the second device may also output, upon completion of backing up the stored data, second prompt information instructing the user to run the target application, and start the target application in response to a start operation for the target application.

Operations 301 to 305 are further described below in conjunction with a scenario example.

The user performs an activity through application Z on device E, and synchronizes the data of application Z produced during running of application Z to the cloud server in real time. The device type corresponding to application Z is PC. When device E is no longer accessible to the user due to movement of the user, the user wants to transfer the service of application Z. The user opens tablet F to request the data of application Z from the cloud server. However, since the device type of tablet F is not PC, tablet F cannot successfully obtain the data of application Z, and the service of application Z cannot be transferred to tablet F. The user turns on computer G, successfully obtains, through a request, the data of application Z from the cloud server, starts application Z, and controls application Z to automatically recover, based on the data, the last activity of application Z performed on device E.

With the above methods, the first device stores, through the first data management module, the persistent data and temporary data of the target application produced during running of the target application as stored data, and sends the stored data to the second device through the first data management module. The second device receives the stored data through the second data management module, and upon completion of backing up the stored data, the second device runs the target application based on the stored data. Since the stored data includes not only the persistent data of the target application produced during running of the target application, but also the temporary data, the service of the target application can be transferred from the first device to the second device regardless of whether the target application is running on the first device, which effectively reduces the limitations on the service transfer.

Furthermore, before the first device or the cloud server sends the stored data to the second device, it may first identify the device type of the second device, and send the stored data to the second device when the identification result indicates that the device type of the second device matches the device type indicated by the device type information, which can effectively avoid the service of the target application from being transferred to an inappropriate device.

As illustrated in FIG. 4, a structural block diagram of a service transfer apparatus disclosed in the embodiments of the present disclosure is shown. The service transfer apparatus shown in FIG. 4 is applicable to the first device. The service transfer apparatus shown in FIG. 4 may include a data storage unit 401 and a data sending unit 402.

The data storage unit 401 is configured to store, through the first data management module, data of a target application as stored data, where the stored data includes persistent data and temporary data of the target application produced during running of the target application.

The data sending unit 402 is configured to send the stored data to the second device through the first data management module, so that the second device obtains the stored data upon completion of backing up the stored data through a second data management module, and runs the target application based on the stored data. The second data management module is run on the second device.

In some embodiments, regarding storing, through the first data management module, the data of the target application as the stored data, the data storage unit 401 may be specifically configured to: perform, through the first data management module, a block operation on the data of the target application to obtain at least one data block, and establish a version record about the at least one data block, where the version record includes a data block identifier and a version identifier of each of the at least one data block; and store the at least one data block and the version record as the stored data.

In some embodiments, regarding performing, through the first data management module, the block operation on the data of the target application to obtain at least one data block, the data storage unit 401 may be specifically configured to perform, through the first data management module, the block operation on the data of the target application according to a data type and/or data entry, to obtain at least one data block.

In some embodiments, the data type includes at least one of: a document type, a running status type, and a configuration type.

In some embodiments, regarding sending the stored data to the second device through the first data management module, the data sending unit 402 may be specifically configured to control the first data management module to send, through a near field communication module of the first device, the stored data to the second device, so that the second device controls the second data management module to receive, through a near field communication module of the second device, the stored data.

In some embodiments, regarding sending the stored data to the second device through the first data management module, the data sending unit 402 may be specifically configured to send the stored data to a cloud server through the first data management module, so that the cloud server sends, upon completion of backing up the stored data, the backed-up data to the second device in response to a data acquisition request sent by the second device. The backed-up data is the stored data or merged data obtained by performing, at the cloud server, a merge operation on the stored data. The cloud server is used to synchronize the data between the first data management module and the second data management module.

In some embodiments, the data storage unit 401 is further configured to obtain, through the first data management module, device type information of a device to receive the transferred service.

Furthermore, regarding sending the stored data to the second device through the first data management module, the data sending unit 402 may be specifically configured to send, through the first data management module, the stored data to a second device whose device type matches the device type indicated by the device type information.

As illustrated in FIG. 5, another structural block diagram of the service transfer apparatus disclosed in the embodiments of the present disclosure is shown. The service transfer apparatus shown in FIG. 5 is applicable to the second device. The service transfer apparatus shown in FIG. 5 may include a first data receiving unit 501 and an application running unit 502.

The first data receiving unit 501 is configured to receive, through the second data management module, stored data sent by the first device through the first data management module. The stored data is obtained by storing, through the first data management module at the first device, data of a target application produced during running of the target application, and the stored data includes persistent data and temporary data of the target application produced during the running of the target application.

The application running unit 502 is configured to run the target application based on the stored data, upon completion of backing up the stored data.

In some embodiments, regarding receiving, through the second data management module, the stored data sent by the first device through the first data management module, the first data receiving unit 501 is specifically configured to control the second data management module to receive, through a near-field communication module of the second device, the stored data sent by the first device through a near-field communication module of the first device.

In some embodiments, regarding receiving, through the second data management module, the stored data sent by the first device through the first data management module, the first data receiving unit 501 is specifically configured to: send a data acquisition request to the cloud server, so that the cloud server sends backed-up data to the second device, the backed-up data is the stored data or merged data obtained by performing, at the cloud server, a merge operation on the stored data, and the cloud server is used to synchronize the data between the first data management module and the second data management module; and receive the backed-up data through the second data management module.

As illustrated in FIG. 6, a further structural block diagram of the service transfer apparatus disclosed in the embodiments of the present disclosure is shown. The service transfer apparatus shown in FIG. 6 is suitable for the cloud server. The service transfer apparatus shown in FIG. 6 may include a second data receiving unit 601 and a data delivery unit 602.

The second data receiving unit 601 is configured to receive stored data sent by the first device through the first data management module. The stored data is obtained by storing, through the first data management module at the first device, data of a target application produced during running of the target application, and the stored data includes persistent data and temporary data of the target application produced during the running of the target application.

The data delivery unit 602 is configured to send, upon completion of backing up the stored data, the backed-up data to the second device in response to a data acquisition request sent by the second device, so that the second device receives the backed-up data through the second data management module and runs the target application based on the backed-up data. The backed-up data is the stored data or merged data obtained by performing, at the cloud server, a merge operation on the stored data, and the cloud server is used to synchronize the data between the first data management module and the second data management module.

In some embodiments, regarding sending the backed-up data to the second device in response to the data acquisition request sent by the second device, the data delivery unit 602 is specifically configured to send the backed-up data to the second device in response to the data acquisition request sent by the second device when the device type of the second device matches the device type indicated by the device type information of a device to receive the transferred service. The device type information is obtained and sent by the first device through the first data management module.

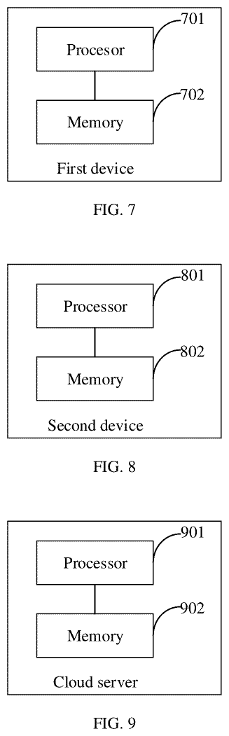

As illustrated in FIG. 7, a structural block diagram of the first device disclosed in the embodiments of the present disclosure is shown. The first device shown in FIG. 7 may include a processor 701 and a memory 702 coupled to the processor 701. The memory 702 may store one or more computer programs.

The processor 701 may include one or more processing cores. The processor 701 uses various interfaces and lines to connect various parts within the entire first device, and performs various functions of the first device and processes data by running or executing instructions, programs, code sets or instruction sets stored in the memory 702, and calling data stored in the memory 702. Optionally, the processor 701 may be implemented in at least one hardware form of digital signal processing (DSP), field-programmable gate array (FPGA), and programmable logic array (PLA). The processor 701 may integrate one or a combination of a central processing unit (CPU), a graphics processing unit (GPU), a modem, and the like. The CPU mainly processes the operating system, user interface and applications. The GPU is responsible for rendering and drawing display content. The modem is used to handle wireless communications. It is understandable that the modem may not be integrated into the processor 701, but may be implemented separately through a communication chip.

The memory 702 may include a random access memory (RAM) or a read-only memory (ROM). The memory 702 may be used to store instructions, programs, codes, code sets, or instruction sets. The memory 702 may include a program storage area and a data storage area. The program storage area may store instructions for implementing an operating system, instructions for implementing at least one function (such as a touch function, a sound playback function, and an image playback function), instructions for implementing the above-mentioned various method embodiments, etc. The data storage area may also store data created by the first device during use.

In the embodiments of the present disclosure, the processor 701 is also configured to:
store, through the first data management module, data of a target application as stored data, where the stored data includes persistent data and temporary data of the target application produced during running of the target application; and
send, through the first data management module, the stored data to a second device, so that the second device obtains the stored data upon completion of backing up the stored data through a second data management module, and runs the target application based on the stored data, where the second data management module is run on the second device.

In the embodiments of the present disclosure, the processor 701 is further configured to:
perform, through the first data management module, a block operation on the data of the target application to obtain at least one data block, and establish a version record about the at least one data block, where the version record includes a data block identifier and a version identifier of each of the at least one data block, and store the at least one data block and the version record as the stored data.

In the embodiment of the present disclosure, the processor 701 is further configured to:
perform, through the first data management module, the block operation on the data of the target application according to a data type and/or a data entry to obtain the at least one data block.

In the embodiments of the present disclosure, the data type includes at least one of a document type, a running status type, and a configuration type.

In the embodiments of the present disclosure, the processor 701 is further configured to:
control the first data management module to send, through a near field communication module of the first device, the stored data to the second device, so that the second device controls the second data management module to receive, through a near field communication module of the second device, the stored data.

In the embodiment of the present disclosure, the processor 701 is further configured to:
send, through the first data management module, the stored data to a cloud server, so that the cloud server sends, upon completion of backing up the stored data, the backed-up data to the second device in response to a data acquisition request sent by the second device, where the backed-up data is the stored data or merged data obtained by performing, at the cloud server, a merge operation on the stored data, and the cloud server is configured to synchronize the data between the first data management module and the second data management module.

In the embodiment of the present disclosure, the processor 701 is further configured to:
obtain, through the first data management module, device type information of a device to receive a transferred service; and
send, through the first data management module, the stored data to a second device whose device type matches a device type indicated by the device type information.

As illustrated in FIG. 8, a structural block diagram of the second device disclosed in the embodiments of the present disclosure is shown. The second device shown in FIG. 8 may include a processor 801 and a memory 802 coupled to the processor 801. The memory 802 may store one or more computer programs.

It is notable that, for the detailed description to the processor 801 and the memory 802, reference may be made to the description for the first device in FIG. 7, which will not be repeated here.

In the embodiments of the present disclosure, the processor 801 is further configured to:
receive, through the second data management module, stored data sent by a first device through a first data management module, where the stored data is obtained by storing, through the first data management module at the first device, data of the target application produced during running of the target application, and the stored data includes persistent data and temporary data of the target application produced during the running of the target application; and
run the target application based on the stored data, upon completion of backing up the stored data.

In the embodiment of the present disclosure, the processor 801 is further configured to:
control the second data management module to receive, through a near field communication module of the second device, the stored data sent by the first device through a near field communication module of the first device.

In the embodiment of the present disclosure, the processor 801 is further configured to:
send a data acquisition request to the cloud server, so that the cloud server sends backed-up data to the second device, where the backed-up data is the stored data or merged data obtained by performing, at the cloud server, a merge operation on the stored data, and the cloud server is used to synchronize the data between the first data management module and the second data management module; and receive the backed-up data through the second data management module.

As illustrated in FIG. 9, a structural block diagram of the cloud server disclosed in the embodiments of the present disclosure is shown. The cloud server shown in FIG. 9 may include a processor 901 and a memory 902 coupled to the processor 901. The memory 902 may store one or more computer programs.

It is notable that, for the detailed description to the processor 901 and the memory 902, reference may be made to the description for the first device in FIG. 7, which will not be repeated her.

In the embodiments of the present disclosure, the processor 901 is further configured to:
receive stored data sent by a first device through a first data management module, where the stored data is obtained by storing, through the first data management module at the first device, data of a target application produced during running of the target application, and the stored data includes persistent data and temporary data of the target application produced during the running of the target application; and
upon completion of backing up the stored data, send the backed-up data to the second device in response to a data acquisition request sent by a second device, so that the second device receives the backed-up data through a second data management module and runs the target application based on the backed-up data, where the backed-up data is the stored data or merged data obtained by performing, at the cloud server, a merge operation on the stored data, and the cloud server is used to synchronize the data between the first data management module and the second data management module.

In the embodiments of the present disclosure, the processor 901 is further configured to:
when the device type of the second device matches a device type indicated by device type information of a device to receive the transferred service, send the backed-up data to the second device in response to the data acquisition request sent by the second device, where the device type information is obtained and sent by the first device through the first data management module.

The embodiments of the present disclosure disclose a non-transitory computer-readable storage medium storing a computer program thereon. The computer program, when being executed by a processor, causes the processor to implement part or all of the operations performed by the first device, the second device or the cloud server in the above embodiments.

The embodiments of the present disclosure disclose a computer program product. The computer program product, when running on a computer, causes the computer to implement part or all of the operations executed by the first device, the second device or the cloud server in the above embodiments.

The embodiments of the present disclosure disclose an application publishing platform which is used to publish a computer program product. The computer program product, when running on a computer, causes the computer to implement part or all of the operations executed by the first device, the second device or the cloud server in the above embodiments.

In the above embodiments, all or part of them may be implemented by software, hardware, firmware or any combination thereof. When implemented in software, all or part of them may be implemented in the form of a computer program product.

The computer program product includes one or more computer instructions. The computer program instructions, when being loaded and executed on a computer, cause the processes or functions according to the embodiments of the present disclosure to be implemented in whole or in part. The computer may be a general purpose computer, a special purpose computer, a computer network, or other programmable device. The computer instructions may be stored in a computer-readable storage medium or transmitted from one computer-readable storage medium to another computer-readable storage medium. For example, the computer instructions may be transmitted from one website, computer, cloud server, or data center to another website, computer, cloud server, or data center via wired means (e.g., coaxial cable, optical fiber, digital subscriber line (DSL)) or wireless means (e.g., infrared, wireless, and microwave). The computer-readable storage medium may be any available medium that can be stored by a computer or a data storage device such as a cloud server or a data center that includes one or more available media. The available media may be magnetic media (e.g., floppy disk, magnetic disk, and tape), optical media (e.g., DVD), or semiconductor media (e.g., Solid State Disk (SSD)).

Those skilled in the art can clearly understand that, for the convenience and brevity of description, the specific working processes of the systems, apparatuses and units described above may refer to the corresponding processes in the aforementioned method embodiments, which will not be repeated here.

In several embodiments provided in the disclosure, it is understandable that the disclosed systems, apparatuses and methods may be implemented in other ways. For example, the apparatus embodiments described above are merely illustrative. For example, the division of units is merely a logical function division. There may be other division manners in actual implementation. For example, multiple units or components may be combined or integrated into another system, or some features may be ignored or not executed. In addition, the mutual coupling or direct coupling or communication connection shown or discussed may be an indirect coupling or communication connection through some interface, apparatus or unit, which may be electrical, mechanical or in other forms.

The units described as separate components may or may not be physically separated, and the components shown as units may or may not be physical units, that is, they may be located in one place or may be distributed over multiple network units. Some or all of the units may be selected according to actual needs to achieve the purpose of the solution in the embodiments.

In addition, the individual functional units in each embodiment of the present disclosure may be integrated into one processing unit, or each unit may exist physically separately, or two or more units may be integrated into one unit. The integrated unit may be implemented in the form of hardware or in the form of software functional unit.

If the integrated unit is implemented in the form of a software functional unit and sold or used as an independent product, it may be stored in a computer-readable storage medium. Based on this understanding, the technical solutions of the present disclosure, the part thereof that contributes to the related art, or all or part of the technical solutions may essentially be embodied in the form of a software product. The computer software product is stored in a storage medium and includes a number of instructions for enabling a computer device (which may be a personal computer, a cloud server, or a network device, etc.) to execute all or part of the operations of the methods of the embodiments of the present disclosure. The storage medium includes: U disk, mobile disk, read-only memory (ROM), random access memory (RAM), disk or optical disk and other media that can store program codes.

The foregoing is only used to illustrate the technical solutions of the present disclosure, rather than to limit them. Although the present disclosure has been described in detail with reference to the aforementioned embodiments, those of ordinary skill in the art should understand that the technical solutions described in the aforementioned embodiments may still be modified, or some of the technical features may be replaced by equivalents. However, these modifications or replacements do not deviate the essence of the corresponding technical solutions from the spirit and scope of the technical solutions of the embodiments of the present disclosure.

What is claimed is:

1. A service transfer method, for a first device, wherein a first data management module is run on the first device, and the method comprises:
storing, through the first data management module, data of a target application as stored data, wherein the stored data comprises persistent data and temporary data of the target application produced during running of the target application; and
sending, through the first data management module, the stored data to a second device, so that the second device runs the target application based on the stored data upon completion of backing up the stored data through a second data management module, wherein the second data management module is run on the second device.

2. The method as claimed in claim 1, wherein the storing, through the first data management module, the data of the target application as the stored data comprises:
performing, through the first data management module, a block operation on the data of the target application and obtaining at least one data block through the block operation, and establishing a version record about the at least one data block, wherein the version record comprises a data block identifier and a version identifier of each of the at least one data block, and
storing the at least one data block and the version record as the stored data.

3. The method as claimed in claim 2, wherein the performing, through the first data management module, the block operation on the data of the target application and obtaining the at least one data block through the block operation, comprises:
performing, through the first data management module, the block operation on the data of the target application according to at least one of a data type and a data entry, and obtaining the at least one data block through the block operation.

4. The method as claimed in claim 3, wherein the data type comprises at least one of a document type, a running status type, and a configuration type.

5. The method as claimed in claim 1, wherein the sending, through the first data management module, the stored data to the second device comprises:
controlling the first data management module to send, through a near field communication module of the first device, the stored data to the second device, so that the second device controls the second data management module to receive, through a near field communication module of the second device, the stored data.

6. The method as claimed in claim 1, wherein the sending, through the first data management module, the stored data to the second device comprises:
sending, through the first data management module, the stored data to a cloud server, so that the cloud server sends, upon completion of backing up the stored data, the backed-up data to the second device in response to a data acquisition request sent by the second device, wherein the backed-up data is the stored data or merged data obtained by performing, at the cloud server, a merge operation on the stored data, and the cloud server is configured to synchronize the data between the first data management module and the second data management module.

7. The method as claimed in claim 1, wherein the method further comprises:
obtaining, through the first data management module, device type information of a device to receive a transferred service;
the sending, through the first data management module, the stored data to the second device comprises:
sending, through the first data management module, the stored data to a second device whose device type matches a device type indicated by the device type information.

8. The method as claimed in claim 1, wherein the storing, through the first data management module, the data of the target application as the stored data comprises:
in response to a battery power of the first device being lower than a power threshold, outputting first prompt information indicating that a service of the target application is to be transferred; and
in response to a service transfer operation for the target application, storing, through the first data management module, the data of the target application as the stored data.

9. The method as claimed in claim 2, wherein the sending, through the first data management module, the stored data to the second device comprises:
performing, through the first data management module, a merge operation on the stored data, and obtaining merged data through the merge operation, and
sending, through the first data management module, the merged data to the second device.

10. A service transfer method, for a second device, wherein a second data management module is run on the second device, and the method comprises:
receiving, through the second data management module, stored data sent by a first device through a first data management module, wherein the stored data is obtained by storing, through the first data management module at the first device, data of a target application produced during running of the target application, and the stored data comprises persistent data and temporary data of the target application produced during the running of the target application; and
running the target application based on the stored data, upon completion of backing up the stored data.

11. The method as claimed in claim 10, wherein the receiving, through the second data management module, the stored data sent by the first device through the first data management module comprises:
controlling the second data management module to receive, through a near field communication module of the second device, the stored data sent by the first device through a near field communication module of the first device.

12. The method as claimed in claim 10, wherein the receiving, through the second data management module, the stored data sent by the first device through the first data management module comprises:
sending a data acquisition request to a cloud server so that the cloud server sends backed-up data to the second device, wherein the backed-up data is the stored data or merged data obtained by performing, at the cloud server, a merge operation on the stored data, and the cloud server is configured to synchronize the data between the first data management module and the second data management module; and
receiving the backed-up data through the second data management module.

13. An electronic device, comprising:
a memory storing executable program codes; and
a processor coupled to the memory;
wherein a first data management module is run on the electronic device, the processor is configured to call the executable program codes stored in the memory, and the executable program codes, when being executed by the processor, cause the processor to:
store, through the first data management module, data of a target application as stored data, wherein the stored data comprises persistent data and temporary data of the target application produced during running of the target application; and
send, through the first data management module, the stored data to a further electronic device, so that the further electronic device runs the target application based on the stored data upon completion of backing up the stored data through a second data management module, wherein the second data management module is run on the further electronic device.

14. The electronic device as claimed in claim 13, wherein the processor is further caused to:
perform, through the first data management module, a block operation on the data of the target application and obtain at least one data block through the block operation;
establish a version record about the at least one data block, wherein the version record comprises a data block identifier and a version identifier of each of the at least one data block, and
store the at least one data block and the version record as the stored data.

15. The electronic device as claimed in claim 14, wherein the processor is further caused to:
perform, through the first data management module, the block operation on the data of the target application according to at least one of a data type and a data entry.

16. The electronic device as claimed in claim 15, wherein the data type comprises at least one of a document type, a running status type, and a configuration type.

17. The electronic device as claimed in claim 13, wherein the processor is further caused to:
control the first data management module to send, through a near field communication module of the electronic device, the stored data to the further electronic device, so that the further electronic device controls the second data management module to receive, through a near field communication module of the further electronic device, the stored data.

18. The electronic device as claimed in claim 13, wherein the processor is further caused to:
send, through the first data management module, the stored data to a cloud server, so that the cloud server sends, upon completion of backing up the stored data, the backed-up data to the further electronic device in response to a data acquisition request sent by the further electronic device, wherein the backed-up data is the stored data or merged data obtained by performing, at the cloud server, a merge operation on the stored data, and the cloud server is configured to synchronize the data between the first data management module and the second data management module.

19. The electronic device as claimed in claim 13, wherein the processor is further caused to:
obtain, through the first data management module, device type information of a device to receive a transferred service; and
send, through the first data management module, the stored data to a further electronic device whose device type matches a device type indicated by the device type information.

20. The electronic device as claimed in claim 13, wherein the processor is further caused to:
in response to a battery power of the electronic device being lower than a power threshold, outputting first prompt information indicating that a service of the target application is to be transferred; and
in response to a service transfer operation for the target application, store, through the first data management module, the data of the target application as the stored data.
